(19) United States
(12) Patent Application Publication
(10) Pub. No.: US 2023/0122936 A1
(43) Pub. Date: Apr. 20, 2023

(54) COMPOSITE STRUCTURE PROVIDED WITH A THERMAL PROTECTION DEVICE WITH HOLLOW FIBERS, IN PARTICULAR FOR A LIQUID HYDROGEN TANK

(71) Applicant: AIRBUS (SAS), Blagnac (FR)

(72) Inventors: Sylvain CHATEL, BLAGNAC CEDEX (FR); Stéphane BECHTEL, BLAGNAC CEDEX (FR); Caroline PETIOT, BLAGNAC CEDEX (FR); Serge MAISON, BLAGNAC CEDEX (FR)

(21) Appl. No.: 17/967,487

(22) Filed: Oct. 17, 2022

(30) Foreign Application Priority Data
Oct. 18, 2021 (FR) 2111025

(51) Int. Cl. C08J 5/04; C08K 7/24

(52) U.S. Cl. CPC C08J 5/0405; C08J 5/046; C08K 7/24; C08J 2300/00

(57) ABSTRACT

A composite structure is disclosed forming part of a wall of a liquid hydrogen tank, and including at least one thermal protection device having one or more of hollow fibers, such as to create thermal protection, for example a thermal barrier or a heat exchanger, which makes it possible to protect the composite structure in case of a high temperature gradient between the two faces thereof, while benefiting from the advantages of a composite material in terms of mass.

### CROSS REFERENCE TO RELATED APPLICATION

This application claims priority to and incorporates by reference the entirety of French Application Number FR 2111025, filed Oct. 18, 2021.

### TECHNICAL FIELD

The present disclosure relates to a composite structure provided with a thermal protection device with hollow fibers, and more specifically, for a wall of a liquid hydrogen tank, as well as a liquid hydrogen tank including at least one wall provided with a composite structure of this type.

### BACKGROUND

Although not exclusively, the present disclosure applies more particularly to the production of a composite structure which is designed to be used in a liquid hydrogen tank, for example a tank which equips an aircraft, and in particular a transport plane.

It is known that hydrogen at ambient pressure and temperature is in gaseous form. This gaseous state is not suitable for storage in this type of application, since, as hydrogen has low density, it involves providing a very large volume of tank or a high pressure in order to be able to contain a substantial quantity of hydrogen. A solution for solving this problem consists of storing the hydrogen in the liquid state, by keeping it at a very low temperature (at −253° C.), in a hermetically sealed container, hydrogen being a particularly volatile component.

In the case of a liquid hydrogen tank for an aircraft, wherein the mass is a significant factor, it can be envisaged to use a composite material instead of a metal for the wall of the tank. However, within the context of development of a structure made of stratified composite material comprising fibers embedded in a matrix, for a wall of a liquid hydrogen tank, the control of the temperature gradient from −253° C. (20K) and at 20° C. (77K), i.e. between the temperatures in the interior and on the exterior of the tank, appears highly problematic in view of the risk of evaporation of the liquid hydrogen and associated leakages. In particular, with the thermal gradient generating a gradient of deformation by differential expansion, this differential expansion will assist loss of cohesion between the fibers and the matrix, as well as loss of cohesion between the folds of the stratified composite material. Thus, cracking can be initiated as a result of the difference of coefficient of expansion between the fibers and the matrix, in addition to as a result of expansion of the matrix. More specifically, micro-cracks join or rejoin a fiber/matrix interface, and can create a crack which will then propagate. Cracking of this type can develop into delamination at the interface between the folds.

Thus, after coalescence of the cracks in the stratified composite material, a hydrogen leak can be established uncontrollably, which causes a significant risk for the safety of the composite structure.

There is therefore a need to have a solution which makes it possible to provide thermal protection for a structure which is designed to be used in applications in which a high temperature gradient is generated between the two faces of the structure, while benefiting from the advantages of a composite material, in particular in terms of mass.

### SUMMARY

The present disclosure embodies a composite structure, and more specifically, for a wall of a liquid hydrogen tank, which makes it possible to fulfil this need.

For this purpose, according to the claimed subject matter, the composite structure comprises at least one thermal protection device, and the thermal protection device comprises one or a plurality of hollow fibers.

Therefore, and as specified in greater detail below, in the composite structure a thermal protection device is provided which makes it possible to protect the composite structure in the case of a high temperature gradient between the two faces of the composite structure. In addition, since this thermal protection device, in particular a heat exchanger or a thermal barrier, is produced on the basis of hollow fibers, it allows the structure to benefit from the advantages of a composite material in particular in terms of mass, in the manner specified below.

The composite structure provided with the thermal protection device has many other advantages indicated hereinafter.

Within the context of the present disclosure, each of the hollow fibers of the thermal protection device comprises at least one longitudinal inner channel, hollowed in the material of the fiber. According to a particular embodiment, at least some of the hollow fibers of the thermal protection device comprise a plurality of longitudinal inner channels.

The hollow fibers of the thermal protection device can be obtained in different manners. At least some of the hollow fibers may correspond to one of the following types of fiber:
carbon fibers;
glass fibers;
thermoplastic fibers (polyamide, polypropylene, etc.);
ceramic fibers;
vegetable fibers.

According to an exemplary embodiment, at least some of the hollow fibers of the thermal protection device are short fibers.

In addition, advantageously, at least some of the hollow fibers of the thermal protection device are incorporated in a polymer matrix. As a variant or as a complement, an arrangement of at least some hollow fibers without incorporation in a matrix is also possible.

In addition, according to an exemplary embodiment, the composite structure comprises at least one layer which is provided both with hollow fibers, as considered in the present invention, and conventional solid fibers.

Within the context of the present disclosure, the hollow fibers of the thermal protection device can be arranged in different manners in the composite structure. According to an exemplary embodiment, the composite structure comprises a plurality of superimposed layers, and at least some of said hollow fibers are arranged in at least one of these layers.

In addition, according to an exemplary embodiment, as a complement to, or a variant of, said first embodiment, the composite structure comprises a plurality of superimposed layers, and at least some of said hollow fibers are arranged between two directly successive superimposed layers.

In addition, according to an exemplary, as a complement to, or a variant of, said first and/or second embodiments, at least one of the hollow fibers is arranged on an outer layer of the composite structure.

In addition, according to an exemplary embodiment, at least one of the hollow fibers of the thermal protection device is produced in the form of a winding tube.

Within the context of the present disclosure, the inner channel(s) of the hollow fibers can be used in different manners. According to an exemplary embodiment, at least some of the hollow fibers are simply filled with a gas. Different types of gas can be used. In particular, according to an exemplary embodiment, the gas is air, whereas, according to a second form, the gas is a neutral gas.

In addition, according to an exemplary embodiment, as a complement to, or as a variant of, said first embodiment, at least some of the hollow fibers have a heat-exchange fluid passing through them, and the thermal protection device comprises at least one supply unit which is configured to circulate the heat-exchange fluid in said hollow fibers.

In addition, according to an exemplary embodiment, as a complement to, or as a variant of, said first and/or second embodiments, at least some of the hollow fibers are put under vacuum, and the thermal protection device comprises at least one vacuum-generating unit which is configured to generate the vacuum in the hollow fibers.

In addition, according to an exemplary embodiment, at least some of the hollow fibers of the thermal protection device comprise an outer covering which is impermeable to hydrogen.

The present disclosure also concerns a liquid hydrogen tank, in particular for an aircraft.

According to an exemplary embodiment, said liquid hydrogen tank comprises at least one wall part which is provided with a composite structure (comprising a thermal protection device) such as the one described above.

### BRIEF DESCRIPTION OF THE DRAWINGS

For an understanding of embodiments of the disclosure, reference is now made to the following description taken in conjunction with the accompanying drawings.

FIG. 1 is a schematic view in perspective of an exemplary embodiment of a composite structure of a stratified type, provided with a polymer resin.

FIG. 2 is a partial perspective view of a hollow fiber provided with a single inner channel.

FIG. 3 is a partial perspective view of a hollow fiber provided with a plurality of inner channels.

FIG. 4 is an exploded schematic view of the composite structure of FIG. 1.

FIG. 5 is a schematic view in perspective of an exemplary embodiment of a composite structure of a stratified type, without resin.

FIG. 6 is a partial schematic perspective view of an exemplary embodiment of a composite structure provided with a layer of short hollow fibers.

FIG. 7 is a partial schematic perspective view of an exemplary embodiment of a composite structure provided with a layer of one-way hollow fibers, and with a unit for circulating heat-exchange fluid.

FIG. 8 is a partial schematic perspective view of an exemplary embodiment of a composite structure provided with a plurality layers of one-way hollow fibers, and with a unit for circulating heat-exchange fluid.

FIG. 9 is a partial schematic perspective view of an exemplary embodiment of a composite structure provided with a single winding tube, and with a unit for circulating heat-exchange fluid.

FIG. 10 is a partial schematic perspective view of an exemplary embodiment of a composite structure provided with a plurality of winding tubes, each of which passes into different layers of the composite structure, and with a unit for circulating heat-exchange fluid.

FIG. 11 is a partial schematic perspective view of an exemplary embodiment of a composite structure provided with a layer of one-way hollow fibers, and with a vacuum-generating unit.

### DETAILED DESCRIPTION

Some embodiments will now be described with reference to the Figures.

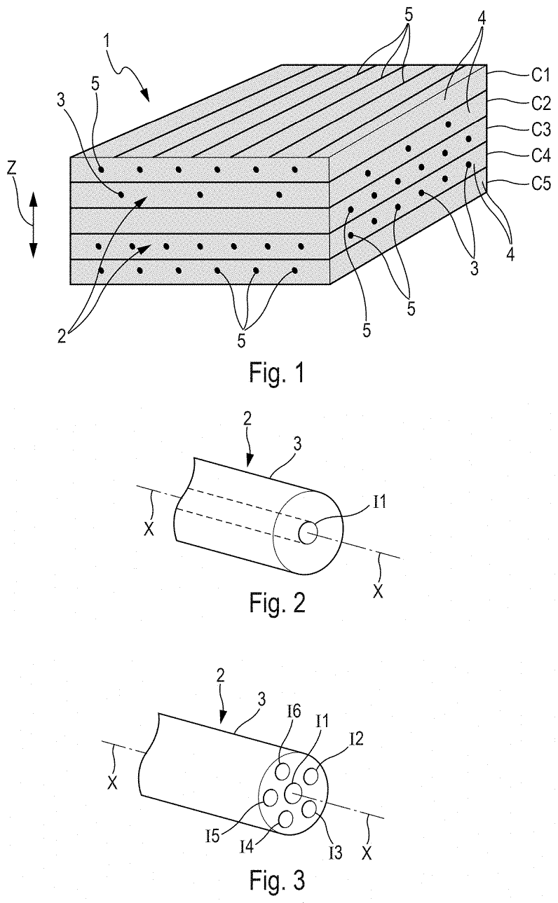

The composite structure 1 which is represented schematically in a particular embodiment in FIG. 1, and makes it possible to illustrate the invention, is a structure made of a composite material, which may be multi-layer.

Although not exclusively, the composite structure 1 is particularly suitable for acting at least partly as a wall of a liquid hydrogen tank.

A liquid hydrogen tank of this type is in particular designed to equip a mobile vehicle which runs at least partly on hydrogen. The tank may be designed to equip an aircraft, in particular a transport plane.

In the example of FIG. 1, the composite structure 1 comprises a plurality of superimposed layers C1 to C5.

According to an exemplary embodiment, the composite structure 1 also comprises a thermal protection device 2.

Also, this thermal protection device 2 comprises one or a plurality of hollow fibers 3, according to the embodiment envisaged.

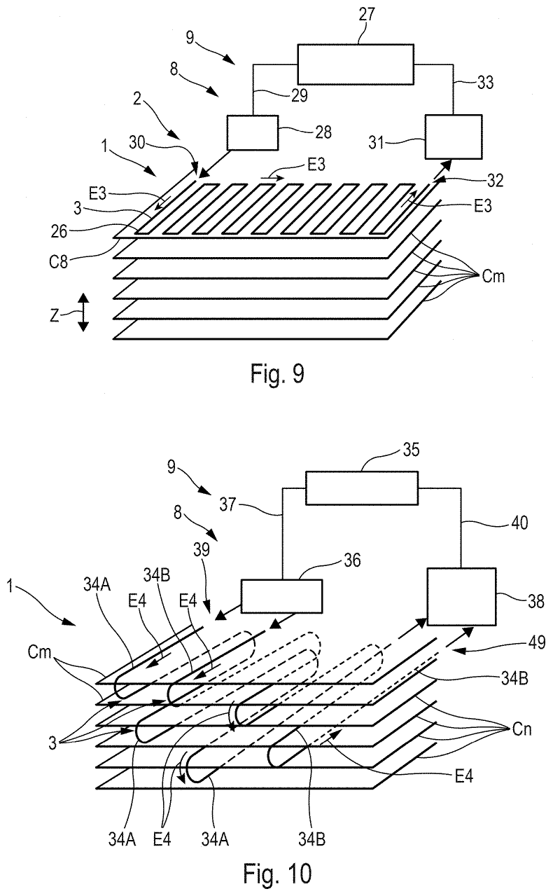

The thermal protection device 2 may comprise a plurality of hollow fibers 3. In the following description, it is considered that the thermal protection device 2 comprises a plurality of hollow fibers, except for the particular embodiment of FIG. 9, which comprises a single hollow fiber, as specified below.

Within the context of the present invention, “hollow fiber” means a fiber 3 which is provided with at least one hollow longitudinal inner channel, i.e. a channel formed in the interior of the material of the fiber, longitudinally (i.e. which extending along the fiber). Generally, the inner channel opens to the exterior of the fiber only at the two longitudinal ends thereof.

According to a first embodiment, a hollow fiber 3 can comprise a single inner channel 11, as represented in FIG. 2. This inner channel 11 can for example be substantially coaxial to a longitudinal axis X-X of the hollow fiber 3, as in the example of FIG. 2, where the inner channel 11 is represented in broken lines. The inner channel can also be positioned differently in the transverse cross-section of the fiber, in particular in any manner.

According to a second embodiment, a hollow fiber 3 can comprise a plurality of inner channels 11, 12, 13, 14, 15 and 16, as represented in FIG. 3. In the example of FIG. 3, the inner channel 11 is substantially coaxial to the longitudinal axis X-X of the hollow fiber 3, and the inner channels 12 to 16 are distributed around the inner channel 11 in the material of the fiber. It will be appreciated that any positioning of the different inner channels in the transverse cross-section of the hollow fiber can be envisaged. Also, the number of inner channels is variable, and can for example be between 2 and 10.

The hollow fibers 3 can be arranged in the composite structure 1 in a manner which is substantially straight (along the longitudinal axis X-X), in a manner which is curved, or in any manner.

Within the context of the present invention, the hollow fibers 3 can be made of different materials. The hollow fibers 3 may be made in a conventional manner, like the conventional fibers of a composite material, and for example of the same material as solid fibers which are also used in the composite structure 1.

According to a first embodiment, the hollow fibers 3 of the thermal protection device 2 are carbon fibers. Carbon fibers of this type are produced using a known conventional production process, which is not described further.

The hollow carbon fibers also have the advantage of being impermeable to hydrogen, which has an additional advantage in the application to a liquid hydrogen tank, as specified below.

In addition, according to a second embodiment, the hollow fibers 3 of the thermal protection device 2 are vegetable fibers, such as, for example, bamboo fibers or linen fibers.

In addition, according to a third embodiment, the hollow fibers 3 of the thermal protection device 2 correspond to one of the following types of fibers:
glass fibers;
thermoplastic fibers (polyamide, polypropylene, etc.);
ceramic fibers.

Within the context of the present invention, the hollow fibers 3 can in particular be:
long fibers, i.e. which have a length equal to the length of the composite structure in a given direction; or
short fibers, which are shorter than the length of the composite structure in the direction in which they are arranged.

Within the context of the present invention, in addition to being able to have forms, sizes and numbers which are different and varied, the hollow fiber(s) 3 can be arranged in different manners, and in different locations of the composite structure 1.

Different embodiments of a composite structure 1 are described hereinafter by way of non-limiting illustration, with reference to FIGS. 1, 5 and 6.

According to a first embodiment represented in FIG. 1, the composite structure 1 comprises a plurality of superimposed layers C1 to C5. The layers C1 to C5 are superimposed on one another in a vertical direction Z. Each of these layers C1 to C5 comprises one-way fibers 3, 5. “One way fibers” means the fact that the fibers concerned, for example the fibers of a layer of the composite structure, are all arranged in the same direction.

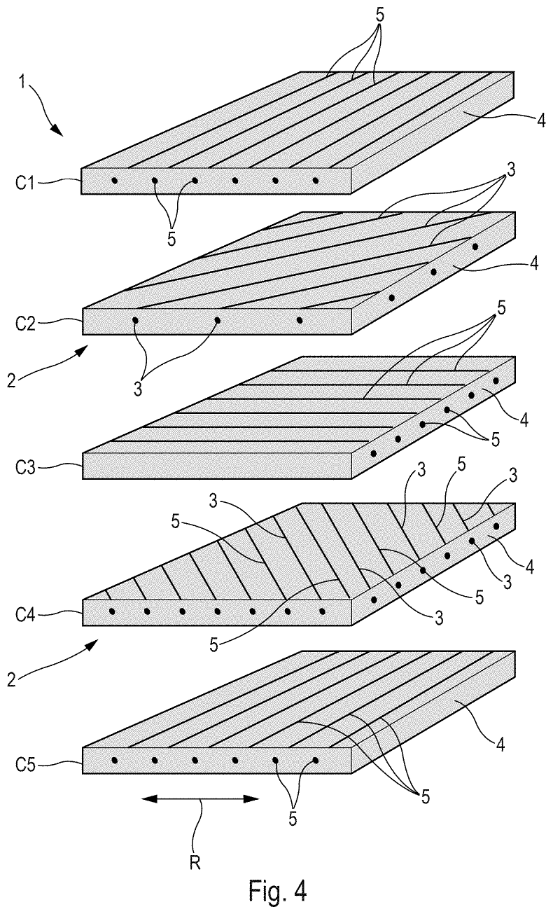

These one-way fibers are embedded in a conventional polymer matrix 4, as represented by a grey-tinted background in FIGS. 1 and 4. This polymer matrix 4 is for example made of cellulose or of polylactic acid.

In order to facilitate the description of the composite structure 1 in FIG. 1, FIG. 4 represents the layers of the composite structure 1 (of this FIG. 1) in an exploded manner, with the layers spaced vertically from one another. In this FIG. 4, R represents an arrow illustrating a reference direction.

In the example in FIG. 1:
the one-way fibers (solid fibers 5) of the layers C1 are oriented in a direction which has an angle of 90° relative to the direction illustrated by the arrow R;
the one-way fibers (hollow fibers 3) of the layer C2 are oriented in a direction which has an angle of 45° relative to the direction illustrated by the arrow R;
the one-way fibers (solid fibers 5) of the layer C3 are oriented in the direction illustrated by the arrow R;
the one way fibers (hollow fibers 3 and solid fibers 5) of the layer C4 are oriented in a direction which has an angle of 135° relative to the direction illustrated by the arrow R; and
the one way fibers (solid fibers 5) of the layer C5 are oriented in a direction which has an angle of 90° relative to the direction illustrated by the arrow R.

It will be appreciated that, as a variant, the orientations can have directions different from those of FIG. 1, and in particular any directions.

In this example, some of the fibers of the composite structure 1 are hollow fibers 3, and other fibers of the composite structure 1 are conventional solid fibers 5. By way of example, the fibers of the layers C2 are hollow fibers 3, and the fibers of the layers C1, C3 and C5 are conventional solid fibers 5.

Within the context of the present invention, “solid fiber” means any fiber which is habitually used in composite materials, with material in all of its transverse cross-section, i.e. a fiber which is not provided with a hollow inner channel. These conventional solid fibers are not described further in the present description.

It is also possible to envisage arranging mixed fibers in a layer, i.e. arranging both hollow fibers 3 and conventional solid fibers 5 in a single layer, as in the layer C4. In the example of this layer C4, the fibers are alternately hollow fibers 3 and solid fibers 5. It will be appreciated that other distributions between the solid fibers and the mixed fibers are possible, and in particular any distribution.

According to a variant of this first embodiment, the composite structure comprises a single composite layer, for example a layer similar to the layer C4.

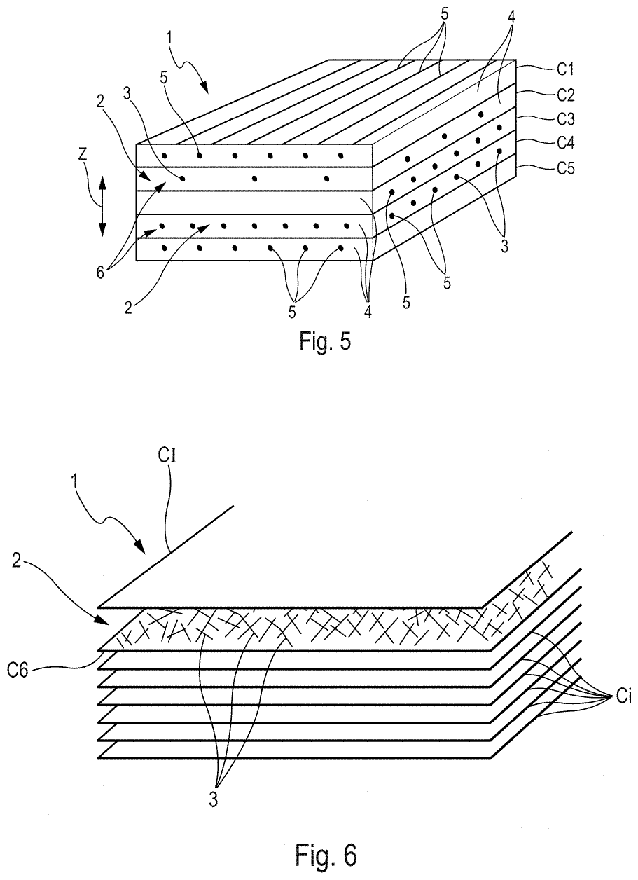

In addition, according to a second embodiment represented in FIG. 5, the composite structure 1 also comprises a plurality of layers C1 to C5 comprising one-way fibers.

However, unlike the composite structure 1 of the first embodiment represented in FIG. 1, the composite structure 1 of FIG. 5 does not comprise a polymer matrix. According to this second embodiment, the fibers 3 and 5 are not embedded in a matrix.

The same types of variants as those indicated above for the first embodiment, for example one-way fibers with varied directions, or different combinations of hollow fibers and solid fibers in a single layer or in different layers, can be envisaged for this second embodiment.

Irrespective of the embodiment envisaged, each of the layers (or folds), which has for example a thickness of between 60 μm and 100 μm, can comprise a plurality of stacks of fibers in its thickness. By way of example, a layer with a thickness of 70 μm can comprise a maximal stack of seven fibers 10 μm in diameter in its thickness. Fibers with smaller diameters, comprising for example a reduced number of inner channels, can permit greater stacking of fibers in a single layer.

In addition, according to a third embodiment represented in FIG. 6, the composite structure 1 is a structure comprising one or a plurality of layers constituted by hollow fibers 3 which are short. In the example of FIG. 6, the composite structure 1 comprises:
a plurality of conventional successive layers Ci which are superimposed. These conventional layers Ci can for example comprise conventional solid fibers embedded in a polymer resin; and
a layer C6 which is arranged on all of the successive layers Ci. this layer C6 comprises short hollow fibers 3.

According to an exemplary embodiment, the short hollow fibers 3 of the layer C6 are positioned randomly, and are held together by a thermoplastic or thermosetting bonding agent. Thus, gaps are naturally created in the layer C6 between these short hollow fibers 3. A form of this type permits circulation of a fluid (neutral gas, air, heat-exchange fluid) in the hollow fibers 3, as well as through the gaps thus created, or maintaining of the hollow fibers and gaps thus created under vacuum.

This form consequently makes it possible to form a layer C6 which is permeable to a fluid, and can be used for the passage of a heat-exchange fluid according to a particular embodiment, as specified below.

In the example of FIG. 6, the layer C6 comprises only hollow short fibers. According to a variant (not represented), the layer C6 can comprise as short fibers both hollow fibers and conventional solid fibers.

According to another variant of this third embodiment, the composite structure can comprise a plurality of layers of hollow fibers, such as the layer C6.

In the embodiment of FIG. 6, the composite structure 1 is also provided with an impermeable layer CI arranged on an outer face of the composite structure 1.

In addition, it can also be envisaged to create a permeable layer, obtained from hollow fibers (and optionally solid fibers) which are woven in a conventional manner.

Within the context of the present invention, the hollow fiber(s) can thus be arranged in different manners and in different locations of the composite structure 1, as illustrated in particular in a non-limiting manner in the preceding examples of FIGS. 1, 5 and 6. It will be appreciated that varied combinations of different characteristics described above can also be envisaged. In particular, a composite structure can be provided which comprises at least two areas, each of which comprises the characteristics of a particular embodiment.

The composite structure 1 thus benefits from the advantages of a composite material, in particular in terms of mass for example, compared with a metal material.

In addition, thanks to the thermal protection device 2, the composite structure 1 also makes it possible to benefit from a significant saving in weight, as a result of the use of hollow fibers, in comparison with use of solid fibers. The hollow fibers, which for example are made of carbon, can generate a saving of mass of approximately 50%, and up to 65%, at the level of the composite structure 1.

In fact, by way of illustration, in the case of a composite structure of carbon hollow fibers embedded in a resin, with a density of the carbon fibers of approximately 1.7 g/cm3, a density of the resin of approximately 1.1 g/cm3, and fibers representing 60% of the volume in a layer with 40% hollowness within each carbon fiber, it is possible to obtain substantial savings in mass.

Within the context of the present invention, the hollow fibers (which can thus have varied characteristics and can be arranged in different manners as specified above), can also be used in different manners, in particular according to the performance levels required and the applications envisaged.

According to a first, simplified embodiment, hollow fibers 3 are simply filled with gas, in particular air. According to a variant embodiment, they are filled with a neutral gas.

The thermal protection device 2 corresponds in this first embodiment to a thermal barrier 6 (FIG. 5), which makes it possible to limit the heat exchanges by means of the inner channels of the hollow fibers 3 (which may also be impermeable to hydrogen, by nature in the case of carbon in particular, or by means of specific protection, if protection of this type is provided). The hollow fibers 3 make it possible to reduce the thermal conductivity of the composite part 1 because of lower thermal conductivity of the hollow fibers in comparison with the conventional solid fibers.

This first embodiment can be applied to the different possible forms of composite layers provided with hollow fibers, and in particular to those of FIGS. 1, 5 and 6, and to the corresponding variants described.

By way of illustration, the thermal protection device 2 of the composite structure 1 of FIG. 5 comprises a thermal barrier 6 of this type. More specifically, the layer C4, the hollow fibers 3 of which are provided with a gas in this example, has reduced thermal conductivity in comparison with the other conventional layers of the composite structure 1, and thus constitutes a thermal barrier 6 between the layers C3 and C5 between which it is arranged. The composite structure 1 thus incorporates a thermal barrier which makes it possible to limit the transmission of heat.

According to this first embodiment, instead of introducing a gas (such as air or a neutral gas) into the hollow fibers 3, it can also be envisaged to create a vacuum in the inner channels of the hollow fibers 3, and to maintain this vacuum by closing the longitudinal ends of these inner channels. A vacuum of this type makes it possible to limit the thermal conductivity.

Instead of being a passive thermal protection device (generating a heat barrier), the thermal protection device can also be active or dynamic. Such an active or dynamic thermal protection device can be configured to generate a fluid circulation (neutral gas, air, heat-exchange fluid) in the hollow fibers 3 et in particular corresponding to a heat exchanger or to generate the vacuum in the hollow fibers, as specified below.

In addition, according to a second embodiment, the thermal protection device 2 is configured to circulate a heat-exchange fluid in the hollow fibers 3. For this purpose, the thermal protection device 2, which corresponds to a heat exchanger 8, also comprises a supply unit 9, which is configured to circulate the heat-exchange fluid in said hollow fibers 3. According to a second embodiment, the thermal protection device 2 is thus a device of the active or dynamic type.

Different forms can be envisaged.

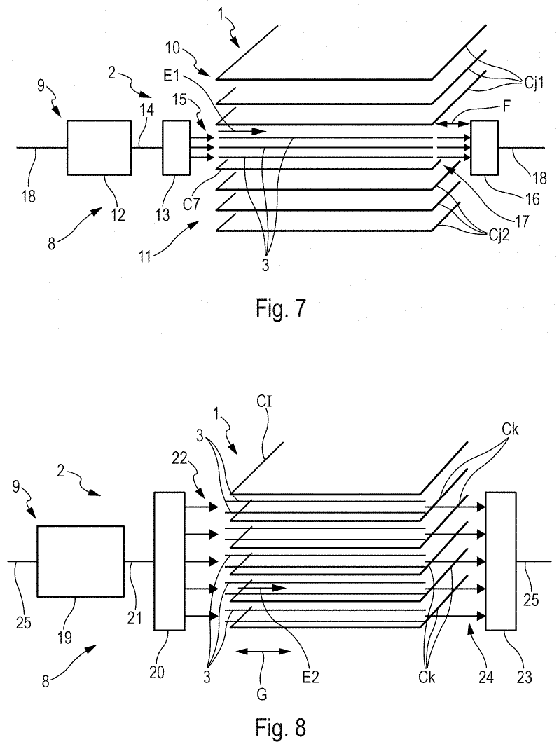

By way of illustration, according to a first form (of this second embodiment) represented in FIG. 7, the composite structure 1 comprises an assembly 10 of conventional layers Cj1 provided with solid fibers (not represented), and an assembly 11 of conventional layers Cj2 provided with solid fibers (not represented), as well as a layer C7 arranged between the two assemblies 10 and 11. This layer C7 is provided with one-way hollow fibers 3, oriented in a (single) direction illustrated by a double arrow F.

The assembly 10 of layers Cj1 forms for example a first stratified unit, and the assembly 11 of layers Cj2 forms a second stratified unit. The layer C7 is thus arranged between these first and second stratified units.

According to this first form, the supply unit 9 comprises:
a circulation device 12, which is configured to circulate heat-exchange fluid, in particular at a required temperature;
an interface unit 13, which is configured to make the heat-exchange fluid (put into circulation by the circulation device 12, and received by means of a duct 14) enter at an end 15 which is upstream (relative to the direction E1 of circulation of the heat-exchange fluid in the hollow fibers 3 of the layer C7) of the composite structure 1, into the assembly of the inner channels of the hollow fibers 3 of the layer C7; and
an interface unit 16, which is configured to recuperate all of the heat-exchange fluids at the output from the inner channels of the hollow fibers 3 at a downstream end 17 of the composite structure 1, and return them to the circulation device 12 by means of a duct 18.

In addition, according to a second form (of this second embodiment) represented in FIG. 8, the composite structure 1 comprises a plurality of layers Ck each comprising one-way hollow fibers 3, arranged in a single direction, illustrated by an arrow G.

According to this second form, the supply unit 9 of the thermal protection device 2 (which corresponds to a heat exchanger 8) comprises:
a circulation device 19, identical for example to the circulation device 12, which is configured to circulate heat-exchange fluid in particular at a required temperature;
an interface unit 20, configured to enter the heat-exchange fluid (which is circulated by the circulation device 19 and received by means of a duct 21), at an end 22 which is upstream (relative to the direction of circulation E2 of the heat-exchange fluid in the hollow fibers 3 of the layers Ck) of the composite structure 1, into the assembly of the inner channels of the hollow fibers 3 of the layers Ck; and
an interface unit 23, configured to recuperate all of the heat-exchange fluids at the output from the inner channels of the hollow fibers 3 at a downstream end 24 of the composite structure 1, and return them to the circulation device 19 by means of a duct 25.

According to the embodiment of FIG. 8, the composite structure 1 is also provided with an impermeable layer CI arranged on an outer face of the composite structure 1.

According to the first and second forms of this second embodiment, the thermal protection device 2 comprises a plurality of hollow fibers 3 provided in the form of long fibers, which have substantially the length of the layer in which they are arranged.

According to this second embodiment (with reference to circulation of heat-exchange fluid), it can also be envisaged to use one or a plurality of longer hollow fibers which are arranged in the form of winding tubes. By way of illustration, different examples are presented hereinafter in the form of a third form represented in FIG. 9, and a fourth form represented in FIG. 10.

According to the third form of FIG. 9, the thermal protection device 2 comprises a single hollow fiber 3 arranged in the form of a winding tube 26 on an outer layer C8 of the composite structure 1. The composite structure 1 also comprises an assembly of successive layers Cm which are superimposed (in a vertical direction Z), and the layer C8 is arranged on this assembly of superimposed layers Cm.

According to this third form, the supply unit 9 of the thermal protection device 2 (which corresponds to a heat exchanger 8) comprises:
a circulation device 27 which is configured to circulate heat-exchange fluid at the required temperature;
an interface unit 28 configured to enter the heat-exchange fluid (which is circulated by the circulation device 27 and received by means of a duct 29) into the inner channel(s) of the hollow fiber 3 forming the winding tube 26, at an upstream end 30 of the winding tube 26 (in the direction E3 of flow of the heat-exchange fluid); and
an interface unit 31 configured to recuperate the heat-exchange fluid at the output from the inner channel(s) of the hollow fiber 3 forming the winding tube 26, at a downstream end 32 (in the direction E3 of flow of the heat-exchange fluid), and return it to the circulation device 27 by means of a duct 33.

In addition, in the fourth form of FIG. 10, the composite structure 1 comprises a plurality of successive superimposed layers Cn forming for example a stratified unit, and the thermal protection device 2 comprises a plurality of hollow fibers 3, each of which is produced in the form of a winding tube 34A, 34B in the composite structure 1. For reasons of clarity of the figure, FIG. 10 represents only two winding tubes 34A and 34B. However, the thermal protection device 2 can comprise a large number of winding tubes of this type.

Each of these winding tubes 34A and 34B passes in succession (continuously) from one layer to the following layer, and for each of the layers it is arranged in the layer.

In this fourth form, the supply unit 9 of the thermal protection device 2 (which corresponds to a heat exchanger 8) comprises:
a circulation device 35 configured to circulate heat-exchange fluid at the required temperature;
an interface unit 36 configured to enter the heat bearing fluid (which is circulated by the circulation device 35 and is received by means of a duct 37), into the inner channel(s) of the assembly of hollow fibers 3 forming the winding tubes 34A and 34B, at an upstream end 39 of the winding tubes 34A and 34B (in the direction E4 of flow of the heat-exchange fluid); and
an interface unit 38 configured to recuperate the heat-exchange fluid at the output from the inner channel(s) of the assembly of hollow fibers 3 forming the winding tubes 34A and 34B, at a downstream end 49 of the winding tubes 34A and 34B (in the direction E4 of flow of the heat-exchange fluid), and return it to the circulation device 35 by means of a duct 40.

According to this second embodiment, and irrespective of the forms envisaged, the circulation of heat-exchange fluid generated in the interior of the composite structure 1 or on an outer face of the composite structure 1 makes it possible to discharge heat, and thus limit the value of the thermal gradient which is withstood in the composite structure 1.

In addition, according to a third embodiment, a vacuum is created in the inner channel(s) of the hollow fibers 3.

According to this third embodiment, the thermal protection device 2 also comprises a vacuum-generating unit 41, which is configured to generate and maintain the vacuum in the hollow fibers 3. According to this third embodiment, the thermal protection device 2, which is configured to maintain the vacuum, is thus of the active type.

This third embodiment can be applied to composite structures similar to those described above for the second embodiment with reference to circulation of a heat-exchange fluid, in particular by providing a vacuum-generating unit instead of a heat-exchange fluid supply unit.

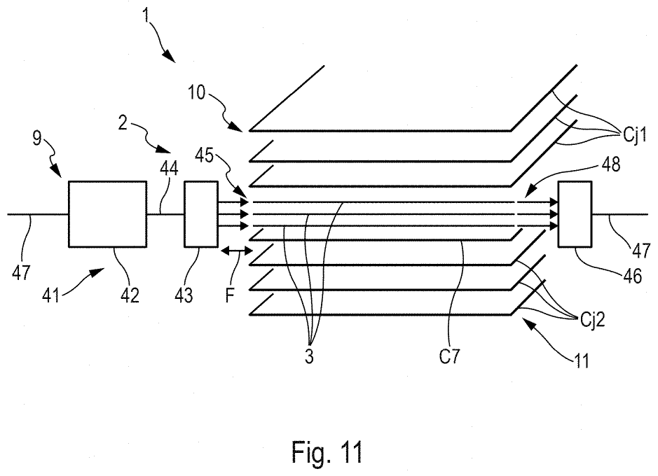

By way of illustration, FIG. 11 represents an example of this third embodiment, which is applied to a structure similar to that of FIG. 7.

The composite structure 1 comprises the assembly 10 of conventional layers Cj1 provided with solid fibers (not represented), and the assembly 11 of conventional layers Cj2 provided with solid fibers (not represented), as well as the layer C7 arranged between the two assemblies 10 and 11, which is provided with one-way hollow fibers 3, oriented in the direction illustrated by the arrow F.

The assembly 10 of layers Cj1 forms for example a first stratified unit, and the assembly 11 of layers Cj2 forms a second stratified unit. The layer C7 is thus arranged between these first and second stratified units.

In this example, the vacuum-generating unit 41 comprises:
a vacuum generator 42;
an interface unit 43 configured to connect the vacuum generator 42 (via a duct 44), to the assembly of the inner channels of the hollow fibers 3 of the layer C7, at a first end 45 of the composite structure 1; and
an interface unit 46 configured to connect the vacuum generator 42 (via a duct 47), to the assembly of the inner channels of the hollow fibers of the layer C7, at a second end 48 of the composite structure 1, opposite the first end 45.

The composite structure 1, as described above, has numerous advantages.

Firstly, the composite structure 1 benefits from the saving in weight inherent in the use of hollow fibers 3 in the thermal protection device 2.

Also, these hollow fibers 3 of the thermal protection device 2:
have properties of thermal conductivity which are lower than those of solid fibers;
can act as a heat-exchange barrier via their inner channels (which may be impermeable to hydrogen); and
can be used (via their inner channels) as a path for circulation of heat-exchange fluid, or as a vacuum-generating space.

In addition, according to a particular embodiment with circulation of heat-exchange fluid in the inner channels of the hollow fibers 3, the hollow fibers 3:
provide thermal protection for the underlying composite layers with successful decrease of the transverse cracking associated with the differential thermal expansions;
provide insulation, via the heat-exchange fluid, in the locations required; and
make it possible to fulfil other functions such as generation of suitable polarity for example.

In addition, in an exemplary application to a liquid hydrogen tank, in which at least part of the wall of the tank comprises a composite structure 1 as described, the thermal protection device 2 of the composite structure 1 participates in establishing the mechanical resistance of the wall, it creates a barrier against the hydrogen, and makes it possible to minimize the evaporation of the liquid hydrogen.

More specifically, the composite structure 1, acting as a wall of the tank used at cryogenic operating temperatures, has a saving of mass in comparison with the conventional solution, which for example is made of metal. This composite structure makes it possible to create thermal insulation and to minimize the level of leakage of gaseous and liquid hydrogen if the wall is damaged.

The minimization of the evaporation of the hydrogen can in particular be obtained by means of a heat exchanger based on the circulation of the heat-exchange fluid in the hollow fibers of the composite structure 1.

In this application to a wall of a liquid hydrogen tank, the inner face of the wall is exposed to the liquid hydrogen at −253° C., and the outer face of the wall is exposed to ambient temperature. The flow which enters the tank must therefore be minimized in order to reduce the evaporation of the liquid hydrogen. With the thermal protection device 2, it can be envisaged to obtain:
a reduction of 5% of the flow entering with a fluid, for example air, circulating in the hollow fibers;
a reduction of between 5 and 80% of the flow entering with a cold heat-exchange fluid circulating in the hollow fibers; and
a reduction of 80% of the flow entering by means of generation of a vacuum in the hollow fibers.

The use of hollow fibers, which for example are made of carbon, consequently makes it possible to combine:
a saving of mass of approximately 50%, and even approximately 65%, at the level of the composite structure 1;
thermal insulation; and
a decrease in the thermal expansion gradient undergone by each layer of the composite structure, thus making it possible to reduce the level of thermo-mechanical stress undergone by each micro-layer of fibers, as well as a decrease in thermo-mechanical shearing between layers with different orientations. Consequently, there is a considerable reduction of the transverse cracking in the layers which are furthest from the layer in contact with the liquid hydrogen.

While at least one exemplary embodiment is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A composite structure for a wall of a liquid hydrogen tank, comprising:
at least one thermal protection device corresponding to a heat exchanger or a thermal barrier, and
wherein the thermal protection device comprises one or a plurality of hollow fibers.

2. The composite structure as claimed in claim 1, wherein at least some of the hollow fibers of the thermal protection device comprise a plurality of longitudinal inner channels.

3. The composite structure as claimed in claim 1, wherein at least some of the hollow fibers of the thermal protection device correspond to one of the following types of fiber:
carbon fibers;
glass fibers;
thermoplastic fibers;
ceramic fibers; or
vegetable fibers.

4. The composite structure as claimed in claim 1, wherein at least some of the hollow fibers of the thermal protection device are short fibers.

5. The composite structure as claimed in claim 1, wherein at least some of the hollow fibers of the thermal protection device are incorporated in a polymer matrix.

6. The composite structure as claimed in claim 1, further comprising at least one layer which is provided with hollow fibers of the thermal protection device and solid fibers.

7. The composite structure as claimed in claim 1, further comprising a plurality of superimposed layers, and wherein at least some of said hollow fibers of the thermal protection device are arranged in at least one of said layers.

8. The composite structure as claimed in claim 1, further comprising a plurality of superimposed layers, and wherein at least some of said hollow fibers of the thermal protection device are arranged between two directly successive superimposed layers.

9. The composite structure as claimed in claim 1, wherein at least one of the hollow fibers of the thermal protection device is arranged on an outer layer of the composite structure.

10. The composite structure as claimed in claim 1, wherein at least one of the hollow fibers of the thermal protection device is produced in the form of a winding tube.

11. The composite structure as claimed in claim 1, wherein at least some of the hollow fibers of the thermal protection device are filled with gas.

12. The composite structure as claimed in claim 1, wherein at least some of the hollow fibers of the thermal protection device have a heat-exchange fluid passing through them, and wherein the thermal protection device comprises at least one supply unit which is configured to circulate the heat-exchange fluid in said hollow fibers.

13. The composite structure as claimed in claim 1, wherein at least some of the hollow fibers of the thermal protection device are put under vacuum, and wherein the thermal protection device comprises at least one vacuum-generating unit which is configured to generate the vacuum in said hollow fibers.

14. The composite structure as claimed in claim 1, wherein at least some of the hollow fibers of the thermal protection device comprise an outer covering which is impermeable to hydrogen.

15. A liquid hydrogen tank, further comprising at least one wall part which is provided with a composite structure as claimed in claim 1.
